(19) United States
(12) Patent Application Publication
(10) Pub. No.: US 2016/0355111 A1
(43) Pub. Date: Dec. 8, 2016

(54) CONTROL SYSTEM FOR A SEAT

(71) Applicant: Caterpillar Inc., Peoria, IL (US)

(72) Inventors: Sean A. Randleman, East Peoria, IL (US); Steven D. Wetherell, East Peoria, IL (US)

(73) Assignee: Caterpillar Inc., Peoria, IL (US)

(21) Appl. No.: 14/827,349

(22) Filed: Aug. 17, 2015

(51) Int. Cl. B60N 2/46; B60N 2/50; B60N 2/52; B60N 2/66; B60N 2/56; B60N 2/02; B60N 2/22

(52) U.S. Cl. CPC B60N 2/4693; B60N 2/4606; B60N 2/0228; B60N 2/501; B60N 2/22; B60N 2/665; B60N 2/5607; B60N 2/525; B60N 2/527

(57) ABSTRACT

A control system for a seat having a base portion and a back portion is provided. The control system includes an arm member coupled to the back portion. The arm member is rotatable about an axis between a storage position and a usage position. The arm member is located adjacent to the back portion in the storage position. Further, the arm member extends from the back portion in the usage portion. The arm member is locked in each of the storage position and the usage position. The control system also includes a plurality of switches disposed on the arm member. Each of the plurality of switches is configured to be manually actuated to control a corresponding component of the seat.

### TECHNICAL FIELD

The present disclosure relates to a control system for controlling a component of a seat.

### BACKGROUND

During various on-highway and off-highway operations, an operator remains seated for extended periods of time while controlling operation of a machine. Therefore, seats are manufactured with various systems, such as height adjustment system and seat suspension system. Such systems may permit the operator to perform tasks comfortably. Typically, such systems are controlled with electric switches that are located on a seat chassis. However, due to space constraints within an operator cabin of the machine, the switches may not be readily visible or accessible to the operator.

U.S. Pat. No. 8,249,781 (the '781 patent) discloses a vehicle seat control system and method. In the vehicle control system of the '781 patent, before a vehicle turns a curve ahead of the vehicle, a control circuit determines lateral acceleration that is expected to occur to the vehicle while the vehicle is turning the curve, and in addition, determines whether a braking operation is performed by a driver before the vehicle turns the curve. When the control circuit determines that an estimation value of the lateral acceleration is greater than a reference value, and that a braking operation has been performed by the driver before the vehicle turns the curve, movable side support portions in a vehicle seat are pivoted in the closing or bending direction. Although the '781 patent provides a system for automatic seat adjustments when the vehicle is maneuvering a curve to provide additional support to the operator, however it does not provide any solution for making adjustments to certain seating components such as height, lumbar support and seating angle as per the operator's personal preference by using an easily accessible control device. The present application provides a solution to meet the above requirement.

### SUMMARY OF THE DISCLOSURE

In one aspect of the present disclosure, a control system for a seat having a base portion and a back portion is provided. The control system includes an arm member coupled to the back portion. The arm member is rotatable about an axis between a storage position and a usage position. The arm member is located adjacent to the back portion in the storage position. Further, the arm member extends from the back portion in the usage portion. The arm member is locked in each of the storage position and the usage position. The control system also includes a plurality of switches disposed on the arm member. Each of the plurality of switches is configured to be manually actuated to control a corresponding component of the seat.

### BRIEF DESCRIPTION OF THE DRAWINGS

FIG. 1 illustrates a front perspective view of a seat having a control system, according to an embodiment of the present disclosure;

FIG. 2 illustrates a rear perspective view of the seat of FIG. 1 with an arm member of the control system in a usage position, according to an embodiment of the present disclosure;

FIG. 3 illustrates a rear perspective view of the seat of FIG. 1 with the arm member in a storage position, according to an embodiment of the present disclosure; and

FIG. 4 illustrates a partial front view of the arm member showing a plurality of switches, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

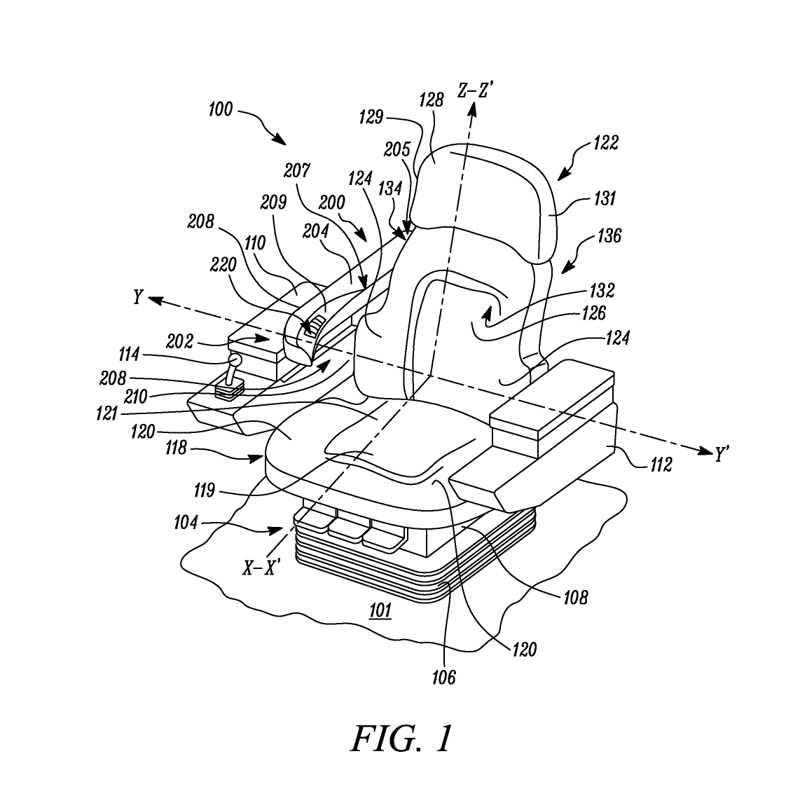

FIG. 1 shows a perspective view of a seat 100 having a control system 200, according to an embodiment of the present disclosure. The seat 100 is provided in an operator cabin (not shown) of a machine (not shown) such that an operator seated on the seat 100 can control various machine operations, for example, use of an implement, machine travel, etc. The seat 100 may be used in dump trucks, haul trucks, off highway trucks or any other machine related to various industries like mining, forestry, waste management, construction, agriculture, transportation etc. Alternatively, the seat 100 can also be used to provide a simulating environment of a real time operation of a machine and impart training to prospective operators.

The seat 100 is supported on a support assembly 104 mounted on a frame 101 of the operator cabin of the machine. The support assembly 104 includes a support member 106 provided to dampen vibrations transmitted from the machine to the seat 100. The support member 106 includes a suspension system (not shown) for absorbing vibrations imparted to the seat 100. Such suspension system includes springs or bellows etc. Alternatively, the suspension system includes pneumatic or hydraulic cylinder arrangements. The support assembly 104 includes a lever (not shown) configured to adjust a height of the seat 100 such that an operator seated can have an optimum visibility of a surrounding at a worksite (not shown).

The support assembly 104 includes a seat frame 108 mounted on the support member 106. The seat 100 also includes a first armrest 110 and a second armrest 112 mounted on the seat frame 108. The first armrest 110 includes a machine operation controller 114. The machine operation controller 114 is a joystick.

The seat 100 includes a base portion 118 defining a longitudinal axis XX″. The base portion 118 is mounted on the seat frame 108. The base portion 118 also includes a central cushion 119 defining a seating surface 121. The central cushion 119 can have suitable configuration to comfortably seat an operator thereon. Such configurations can include suitable contours and depressions to position the operator and to enhance seating comfort.

The base portion 118 also includes base bolsters 120 which are positioned on opposing sides of the central cushion 119. The base bolsters 120 are mounted on the seat frame 108 and the central cushion 119. Further, the base portion 118 includes a pair of first bolster bladders (not shown) positioned within each of the base bolsters 120. The first bolster bladders are provided to hold a volume of pressurized air. The first bolster bladders may include any structure, such as a flexible walled structure, configured to hold the volume of pressurized air. Although pressurized air is described, it may also be contemplated that various other fluids may also be used. Further, the shape of the base bolsters 120 can be varied depending on the volume of pressurized air within the first bolster bladders.

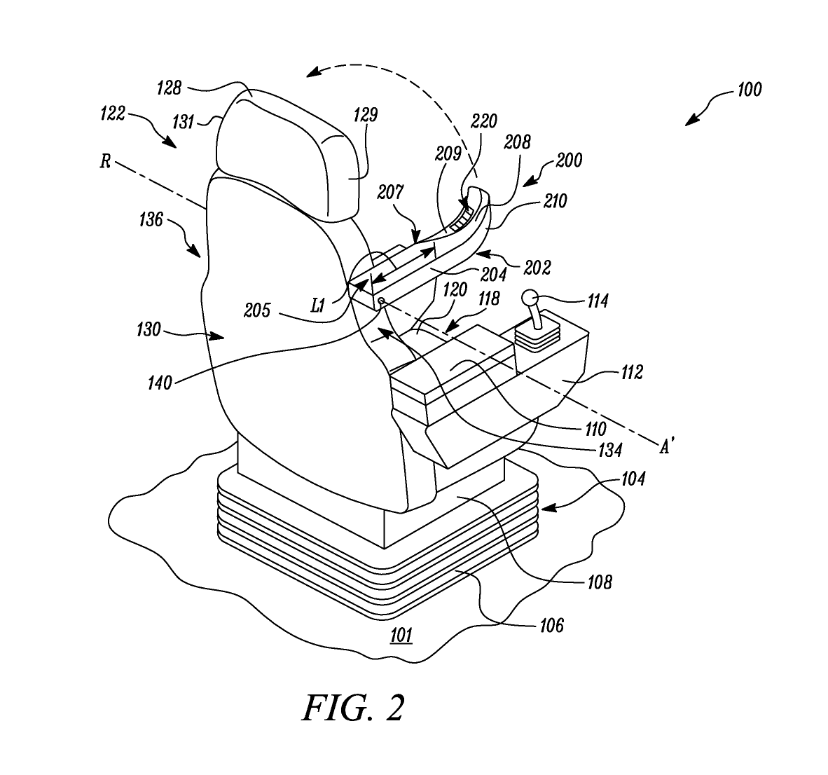

The seat 100 further includes a back portion 122 mounted to the base portion 118. The back portion 122 is rotatable with respect to the base portion 118 about a transverse axis YY″ perpendicular to the longitudinal axis XX′. The back portion 122 further defines a rear surface 130 (shown in FIG. 2) and a front surface 132. The back portion 122 also includes a first lateral side 134 and a second lateral side 136 extending between the rear surface 130 and the front surface 132. The first lateral side 134 and the second lateral side 136 are positioned adjacent to the first armrest 110 and the second armrest 112, respectively.

The back portion 122 includes a lumbar support member 126 provided to support a back of the operator. The back portion 122 further includes a lumbar bladder (not shown) positioned within the lumbar support member 126. The lumbar bladder can hold a volume of pressurized air. Further, a shape of the lumbar support member 126 can be varied depending on the volume of pressurized air within the lumbar bladder. Further, the lumbar support member 126 is movable move along the vertical axis ZZ′ perpendicular to both the longitudinal axis XX′ and the transverse axis YY′. The lumbar support member 126 can be moved along the vertical axis ZZ′ by various actuators (not shown), such as electric motors, hydraulic/pneumatic cylinders. The seat 100 further includes a headrest 128 coupled to the back portion 122 of the seat 100. The headrest 128 is configured to support a head of the operator. The head rest 128 defines a first headrest side 129 and a second headrest side 131. The first headrest side 129 is aligned with the first lateral side 134 of the back portion 122. Further, the second headrest 131 is aligned with the second lateral side 136 of the back portion 122.

The back portion 122 further includes a pair of back bolsters 124 disposed on opposing sides of the lumbar support member 126. The back bolsters 124 are coupled to the lumbar support member 126. Further, the back bolsters 124 includes a pair of second bolster bladders (not shown). The second bolster bladders can hold a volume of pressurized air therein. The second bolster bladders include any structure, such as a flexible walled structure, configured to hold the volume of pressurized air. Further, the shape of the back bolsters 124 can be varied depending on the volume of pressurized air within the second bolster bladders.

The seat 100 also includes a temperature control unit (not shown). The temperature control unit cools or warms the seat 100 based on a user input. In various applications, the temperature control unit may include heat conducting coils disposed within the seat 100 in order to control the temperature of the seat 100.

Referring to FIGS. 1 to 4, the control system 200 for the seat 100 is illustrated. The control system 200 is configured to control a component of the seat 100. The control system 200 is configured to control the base bolsters 120, the back bolsters 124 and the lumbar support member 126. Further, the control system 200 can also be used to control a temperature of the seat 100 via the temperature control unit. Although the control system 200 is described to control the base bolsters 120, the back bolsters 124, the lumbar support member 126 and the temperature of the seat 100, it may be contemplated that the control system 200 can be used to control other functions of the seat 100, such as fore/aft sliding movement, independent height adjustment, back portion reclining movement, storing various positions for one or more operators, adjustable damping functions.

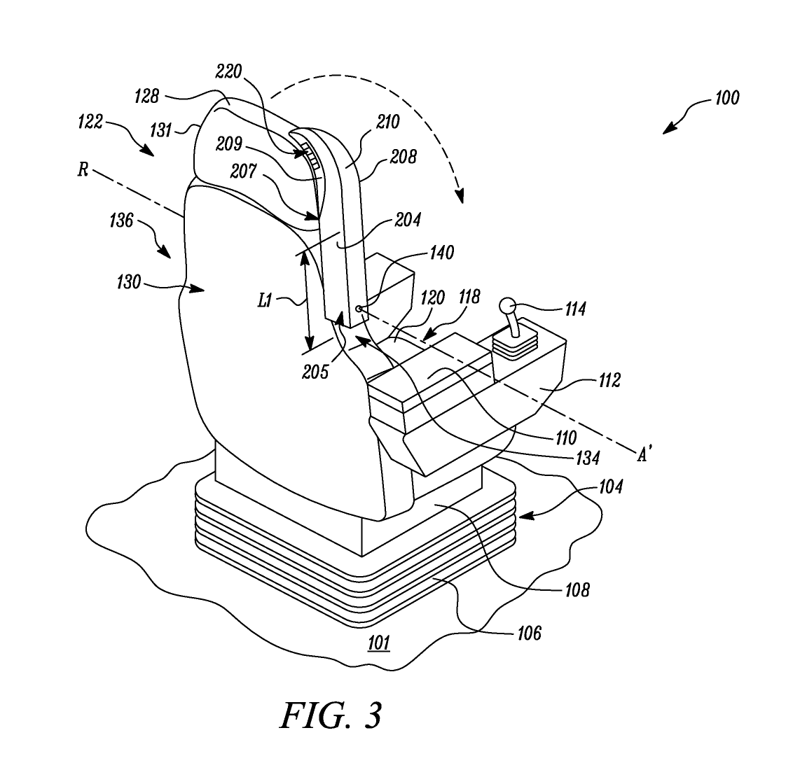

The control system 200 includes an arm member 202 rotatably coupled to the back portion 122 of the seat 100. The arm member 202 includes a first portion 204 and a second portion 208 connected to the first portion 204. The first portion 204 is coupled to the first lateral side 134 of the back portion 122 of the seat 100 via a pivot joint 140 at a first end 205 of the first portion 204. The pivot joint 140 includes a pin (not shown) to rotatably couple the first portion 204 of the arm member 202 with the pivot joint 140. Further, a rotation axis RA′ is defined by the pivot joint 140. The first portion 204 of the arm member 202 is coupled to the first lateral side 134 of the back portion 122 such that the arm member 202 is rotatable about the rotation axis RA′ between a usage position (shown in FIG. 2) and a storage position (shown in FIG. 3). Further, as shown in FIGS. 1 and 2, the first portion 204 has a rectangular cross section. Alternatively, the first portion 204 can have various other shapes such as, circular, oval, elliptical etc.

The second portion 208 of the arm member 202 is inclined with respect to the first portion 204 of the arm member 202. As shown in FIG. 1, a curve is defined between the first portion 204 and the second portion 208 of the arm member 202 such that the second portion 208 extends towards the second armrest 112 in front of the front surface of the back portion 122. The second portion 208 is a curvilinear member defining a first curvilinear surface 209 and a second curvilinear surface 210. The first curvilinear surface 209 of the second portion 208 is positioned in front of an operator seated on the seat 100. Further, a length of second portion 208 can be varied based on various requirements.

Referring to FIG. 2, the arm member 202 extends from the back portion 122 towards the base portion 118 along the transverse axis XX′ in the usage position. The first portion 204 of the arm member 202 is positioned above the first armrest 110 and near to the front surface 132 of the back portion 122 at the usage position. As shown in FIG. 2, the first portion 204 of the arm member 202 defines a length 11′ extending between the first end 205 and the second end 207.

Further, the second portion 208 of the arm member 202 is positioned above the base portion such that the first curvilinear surface 209 of the second portion 208 is positioned in front of the front surface 132 of the back portion 122. In the usage position, the arm member 202 can also be extended along a length thereof, so as to facilitate handling by the operator.

Referring to FIG. 3, the arm member 202 is positioned adjacent to the back portion 122 of the seat 100 in the storage position. The first portion 204 of the arm member 202 is aligned with the first lateral side 134 of the back portion 122. Further, the second portion 208 of the arm member 202 is aligned with the first headrest side 129 of the headrest 128. In an embodiment, the arm member 202 may be movably disposed in a track (not shown) provided on the rear surface 130 of the back portion 122. The track may guide the movement of the arm member 202 about the rotation axis RA′. Further, one or more detents (not shown) may also be provided to lock the arm member 202 in each of the usage position and the storage position. Further, movement of the arm member 202 may be automated or manual.

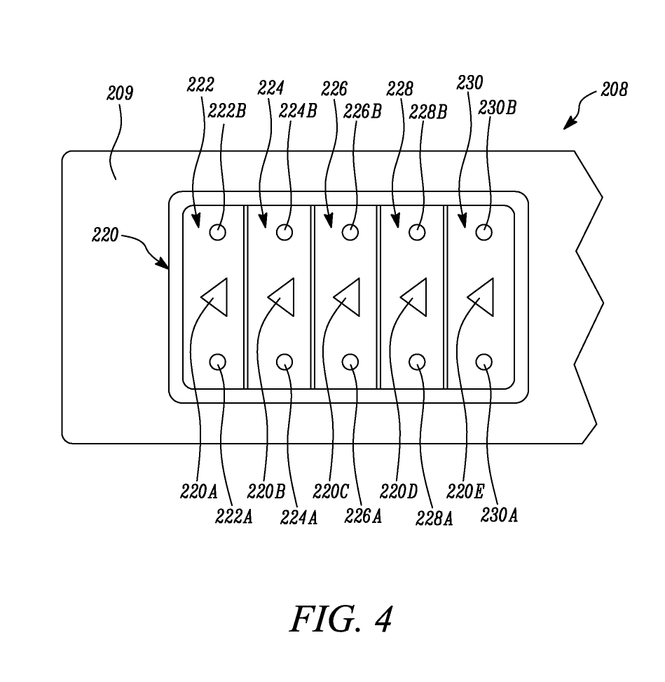

Referring to FIG. 4, the control system 200 further includes a multiple switches 220 provided on the second portion 208 of the arm member 202. The switches 220 are positioned on the first curvilinear surface 209 of the second portion 208 of the arm member 202 such that the switches 220 are positioned in front of the operator in the usage position. Alternatively, the switches 220 may also be disposed on any surface of the arm member 202 such that the switches 220 are aligned for easy access to the operator. Referring to FIG. 4, four such exemplary switches 220 are disposed on the second portion 208 of the arm member 202. The control system 200 includes five membrane switches 222, 224, 226, 228, 230 countersunk into the first curvilinear surface 209 of the second portion 208 of the arm member 202. However, in various alternate embodiments, the control system 200 may include any number of switches depending upon a requirement. In an embodiment, the switches 220 may be integrated with the arm member 202. Alternatively, a control pod having the switches 220 may also be coupled with the arm member 202. Further, each of the switches 220 is manually actuatable to control a corresponding component of the seat 100.

As shown in FIG. 4, each of the switches 220 include first ends 222A, 224A, 226A, 228A, and 230A and second ends 222B, 224B, 226B, 228B, and 230B. Each of the switches also includes markings 220A, 220B, 220C, 220D, and 220E disposed between the first ends and the second ends. Each of the markings is indicative of a corresponding component of the seat 100 being actuated. In an embodiment, the marking corresponds to a pictorial image of a corresponding component being actuated. However, in an alternate embodiment, the markings may also include color markings, letter markings or a combination thereof to indicate corresponding control of the switches 220. Further, one or more indicia may also be provided adjacent to the first and second ends to indicate a corresponding control of the switches 220.

The switch 222 allows an operator to provide an input indicative of varying the shape of the lumbar support member 126. Upon pressing the first end 222A, the controller actuates a valve to inflate the first lumbar bladder such that a volume of the lumbar support member 126 may be increased. Further, upon pressing the second end 222B, the controller actuates the valve to release a volume of pressurized air from the first lumbar bladder such that a volume of the lumbar support member 126 may be decreased.

The switch 224 allows the operator to provide an input indicative of movement of the lumbar support member 126. Upon pressing the first end 224A, the controller moves the lumbar support member 126 upwards along the vertical axis ZZ′. Further, upon pressing the second end 224B, the controller moves the lumbar support member 126 towards the base portion 118 along the vertical axis ZZ′.

The switch 226 allows the operator to provide an input indicative of varying the shape of each of the back bolsters 124. Upon pressing the first end 224A, the controller actuates a valve associated with the second bolster bladders to increase a volume of pressurized air within the second bolster bladders such that volume of the back bolsters 124 may be increased. Further, upon pressing the second end 224B, the controller may actuate the valve to decrease a volume of pressurized air within the second bolster bladders such that volume of the back bolsters 124 may be decreased.

The switch 228 allows the operator to provide an input indicative of varying the shape of each of the base bolsters 120. Upon pressing the first end 226A, the controller actuates a valve associated with the first bolster bladders to increase a volume of pressurized air within the first bolster bladders such that volume of the base bolsters 120 is increased. Further, upon pressing the second end 226B, the controller may actuate the valve to decrease a volume of pressurized air within the first bolster bladders such that volume of the base bolsters 120 is decreased.

The switch 230 allows the operator to vary a temperature of the seat 100. Upon pressing the first end 230A, the controller may warm the seat 100. Further, upon pressing the second end 230B, the controller may cool the seat 100.

Further, the control system 200 also includes a controller (not shown) communicable coupled to the switches 220. The controller may be configured to receive signals/instructions from the switches 220 and actuate a component of the seat 100. In an embodiment, the controller receives signals/instructions and actuates one or more valves associated with a corresponding bladder to increase or decrease a volume of pressurized air therein. Specifically, the controller may selectively regulate a volume of pressurized air within each of the first bolster bladders, the second bolster bladders and the lumbar bladder based on user inputs from the switches 220. In an example, a compressor is also provided for pressurizing the air, or other fluid, in the bladders. The controller communicates, via one or more wires and/or wirelessly, with the switches 220 to selectively vary a volume of pressurized air within the bladders. In particular, the controller may communicate with one or more valves associated with the bladders to control a flow of pressurized air between a compressor and the bladders. The controller may also actuate a movement of the lumbar support member 126 along the vertical axis ZZ′.

The controller may be an electronic controller that operates in a logical fashion to perform operations, execute algorithms, store and retrieve data and other desired operations. The controller may embody a single microprocessor or multiple microprocessors configured to receive signals from the switches 220. Numerous commercially available microprocessors may be configured to perform the functions of the controller. In an embodiment, the controller may be disposed inside the arm member 202. In such a case, the wires may be disposed within the arm member 202. Alternatively, the controller may be disposed separately from the arm member 202.

### INDUSTRIAL APPLICABILITY

The present disclosure related to the control system 200 for the seat 100. The control system 200 is configured to control a component of the seat 100. The control system 200 includes switches 222, 224, 226, 228, and 230 disposed on the arm member 202. The switches 220 are configured to control a corresponding component of the seat 100. The switches 220 are disposed on the first curvilinear surface 209 of the arm member 202. The arm member 202 rotates about the rotation axis RA′ between the storage position and the usage position. Further, in the storage position, the arm member 202 may be disposed in the track provided on the back portion 122 such that the operator may easily move the arm member 202. The arm member 202 is disposed along the first lateral side 134 and the first headrest side 129 such that the arm member 202 is nested along a side profile of the back portion 122. Further, the switches 220 can also be actuated from the storage position of the arm member 202. In the usage position, the arm member 202 can be disposed in front of the operator such that the switches 220 are easily accessible. Thus, the operator can control a corresponding component of the seat 100 while controlling the machine. One or more switch of the switches 220 of the control system 200 can also be enabled or disabled based on worksite protocols. Moreover, shapes and dimensions of the arm member 202 can also be suitably chosen such that the switches 220 are easily accessible to the operator. Specifically, the control system 200 may be conveniently retrifittable with an existing seat.

While aspects of the present disclosure have been particularly shown and described with reference to the embodiments above, various additional embodiments may be contemplated by the modification of the disclosed remote operating station without departing from the spirit and scope of what is disclosed. Such embodiments should be understood to fall within the scope of the present disclosure as determined based upon the claims and any equivalents thereof.

What is claimed is:

1. A control system for a seat having a base portion and a back portion, the control system comprising:
an arm member coupled to the back portion, the arm member being rotatable about an axis between a storage position and a usage position, wherein the arm member is located adjacent to the back portion in the storage position, and the arm member extends from the back portion in the usage position, and wherein the arm portion is locked in each of the storage position and the usage position; and
a plurality of switches disposed on the arm member, each of the plurality of switches being configured to be manually actuated to control a corresponding component of the seat.
